(19) United States
(12) Patent Application Publication
(10) Pub. No.: US 2006/0001614 A1
(43) Pub. Date: Jan. 5, 2006

(54) Apparatus for refreshing voltage data in display pixel circuit and organic light emitting diode display using the same

(76) Inventors: Wei-Chieh Hsueh, Tainan (TW); An Shih, Changhua (TW); Yaw-Ming Tsai, Taichung (TW)

Correspondence Address: Michael D. Bednarek;Shaw Pittman LLP, 1650 Tysons Boulevard, McLean, VA, 22102, US

(21) Appl. No.: 10/882,289

(22) Filed: Jul. 2, 2004

(51) Int. Cl. G09G 3/30

(52) U.S. Cl. 345/76

(57) ABSTRACT

The present invention provides an apparatus for refreshing a voltage data in a display pixel circuit and an organic light emitting diode display using the same. The voltage data is stored in a capacitor of the display pixel circuit. The apparatus includes a data refreshing circuit. The data refreshing circuit includes a voltage transmission terminal coupled to the capacitor, and a first input terminal for inputting a first control signal to control timing and/or period for reading and/or writing the voltage data.

### FIELD OF INVENTION

The present invention relates to an apparatus for refreshing voltage data in a display pixel circuit and an organic light emitting diode display using the same.

### BACKGROUND OF THE INVENTION

The power (P) consumed by a display pixel circuit could be determined by the equation P=CV²F, in which C is the capacitance, V is the drive voltage, and F is the frame rate of the display. The frame rate F means the number of frames displayed per second, namely the frequency of refreshing data in the display pixel circuit. Both the capacitance C and the frame rate F are influenced by the size and resolution of the display. And the performance of transistors in the display pixel circuit determines the drive voltage V.

A display pixel circuit 100 having an organic light emitting diode 102 according to the prior art is shown in FIG. 1. This display pixel circuit 100 includes the organic light emitting diode 102 and a capacitor 104. The capacitor 104 is for storing data. Since there is no apparatus taking over the refreshing of data when the display idles, as shown in FIG. 1, data is refreshed at the same frame rate as that when the display is active; thus the display pixel circuit 100 consumes more power.

### SUMMARY OF THE INVENTION

One aspect of the present invention provides an apparatus for refreshing voltage data in a display pixel circuit and an organic light emitting diode display using the same. This apparatus refreshes data at a lower frame rate when the display becomes idle, then the power consumption is decreased.

The present invention provides an organic light emitting diode display. The organic light emitting diode display includes a plurality of display pixel circuits. Each display pixel circuit includes a capacitor for storing a voltage data, and an apparatus for refreshing the voltage data.

The apparatus for refreshing the voltage data includes a data refreshing circuit. There are many ways to implement the data refreshing circuit. The following structure of the data refreshing circuit is just an example. The data refreshing circuit may include a voltage transmission terminal, a first input terminal and a second input terminal. The voltage transmission terminal is coupled to the capacitor. The first and the second input terminals are respectively for inputting a first control signal and a second control signal to control timing and/or period for reading and/or writing the voltage data. With the first and the second control signals, the apparatus refreshes data at a lower frame rate. Thus the power consumption is decreased.

The data refreshing circuit may further include a memory circuit, a first switch unit and a second switch unit. The memory circuit is for storing the voltage data and includes a first voltage transmission terminal and a second voltage transmission terminal. The memory circuit reads the voltage data through the first voltage transmission terminal, and writes the voltage data through the second voltage transmission terminal. The first switch unit includes a first terminal coupled to the voltage transmission terminal, a second terminal coupled to the first voltage transmission terminal, and a third terminal coupled to the first input terminal. The second switch unit includes a first terminal coupled to the voltage transmission terminal, a second terminal coupled to the second voltage transmission terminal, and a third terminal coupled to the second input terminal.

The first and the second switch units mentioned above may be thin film transistors. A thin film transistor includes a source acting as the first terminal of the switch unit, a drain acting as the second terminal of the switch unit, and a gate acting as the third terminal of the switch unit.

The memory circuit may include a first inverter and a second inverter. Both the first and the second inverters include a first terminal and a second terminal. The first terminal of the first inverter is coupled to the second terminal of the second inverter. The second terminal of the first inverter is coupled to the first terminal of the second inverter. The second terminal of the first inverter is coupled to the first voltage transmission terminal. The first terminal of the second inverter is coupled to the second voltage transmission terminal.

### BRIEF DESCRIPTION OF THE DRAWINGS

For a more complete understanding of the present invention, reference is now made to the following descriptions taken in conjunction with the accompanying drawings.

FIG. 1 depicts a display pixel circuit having an organic light emitting diode according to the prior art;

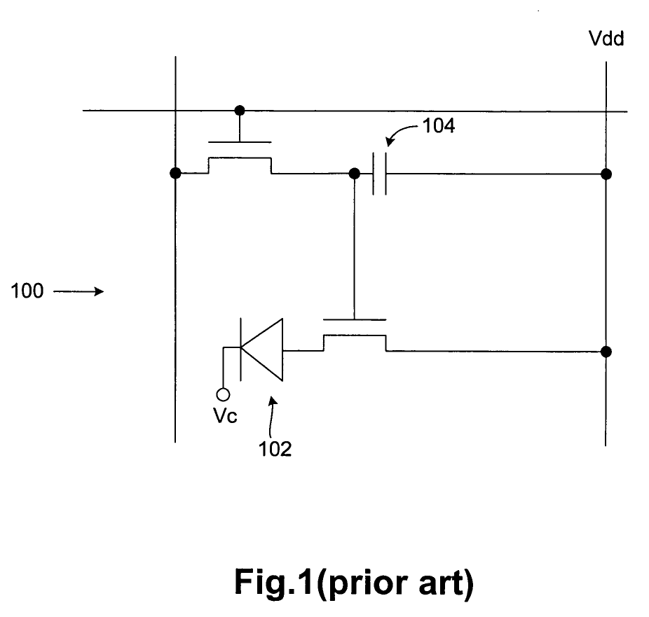

FIG. 2 depicts a combination of an exemplary embodiment of the present invention with a display pixel circuit having an organic light emitting diode; and

FIG. 3 illustrates examples of the first and the second control signals of the present invention.

### DETAILED DESCRIPTION

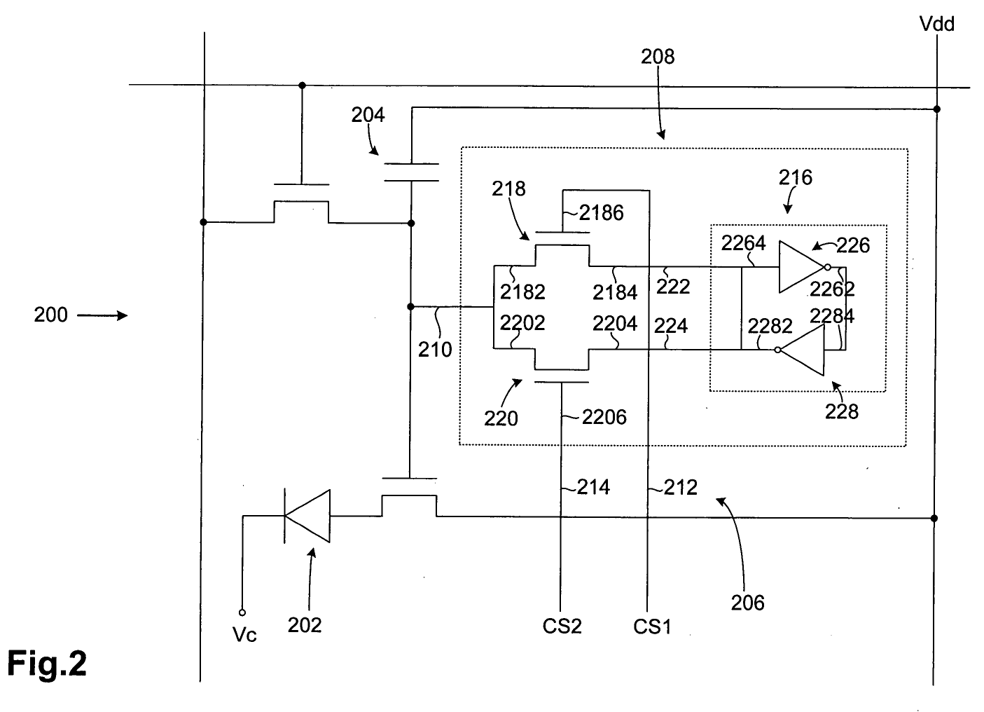

The present invention provides an apparatus for refreshing a voltage data in a display pixel circuit and an organic light emitting diode display using the same. Since this apparatus refreshes the voltage data at a lower frame rate when the display becomes idle, the power consumption is decreased. A display pixel circuit 200 includes an exemplary embodiment of the present invention 206 is shown in FIG. 2. The display pixel circuit 200 has an organic light emitting diode 202. The voltage data is stored in the capacitor 204 of the display pixel circuit 200. The apparatus 206 includes a data refreshing circuit 208. There are many ways to implement the data refreshing circuit 208. The following structure of the data refreshing circuit 208 is just an example. The data refreshing circuit 208 includes a voltage transmission terminal 210, a first input terminal 212 and a second input terminal 214. The voltage transmission terminal 210 is coupled to the capacitor 204. The first input terminal 212 and the second input terminal 214 are respectively for inputting a first control signal CS1 and a second control signal CS2 to control timing and/or period for reading and/or writing the voltage data.

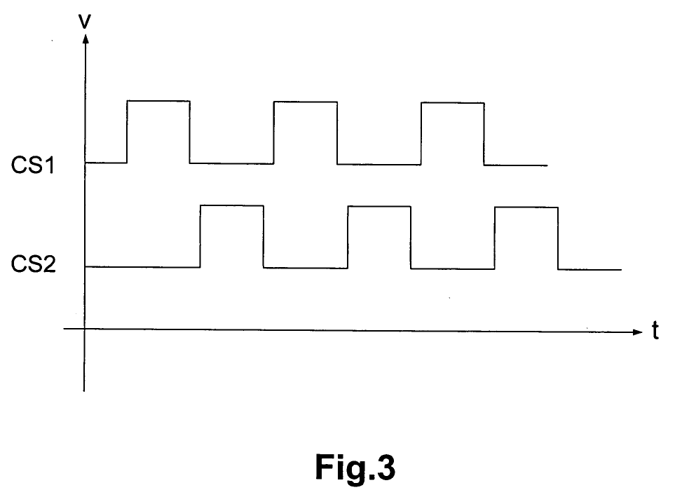

The apparatus 206 would take over the refreshing of the voltage data when the display becomes idle. The apparatus 206 refreshes the voltage data as follows. When receiving the first control signal CS1 through the first input terminal 212, the data refreshing circuit 208 reads the voltage data from the capacitor 204 through the voltage transmission terminal 210 and memorize it. When receiving the second control signal CS2 through the second input terminal 214, the data refreshing circuit 208 writes the voltage data into the capacitor 204 through the voltage transmission terminal 210. The signals CS1 and CS2 can be set to control the frame rate at which the apparatus 206 refreshes the voltage data. Lower frame rate means lower power consumption. Examples of the first control signal CS 1 and the second control signal CS2 are illustrated in FIG. 3.

In this exemplary embodiment, the data refreshing circuit 208 further includes a memory circuit 216, a first thin film transistor 218 and a second thin film transistor 220. The first thin film transistor 218 acts as a first switch unit. The second thin film transistor 220 acts as a second switch unit. The memory circuit 216 is for storing the voltage data and includes a first voltage transmission terminal 222 and a second voltage transmission terminal 224. The memory circuit 216 reads the voltage data through the first voltage transmission terminal 222, and writes the voltage data through the second voltage transmission terminal 224. The first thin film transistor 218 includes a source 2182 coupled to the voltage transmission terminal 210, a drain 2184 coupled to the first voltage transmission terminal 222, and a gate 2186 coupled to the first input terminal 212. The second thin film transistor 220 includes a source 2202 coupled to the voltage transmission terminal 210, a drain 2204 coupled to the second voltage transmission terminal 224, and a gate 2206 coupled to the second input terminal 214.

In this exemplary embodiment, the memory circuit 216 further includes a first inverter 226 and a second inverter 228. The first terminal 2262 of the first inverter 226 is coupled to the second terminal 2284 of the second inverter 228. The second terminal 2264 of the first inverter 226 is coupled to the first terminal 2282 of the second inverter 228. The second terminal 2264 of the first inverter 226 is also coupled to the first voltage transmission terminal 222. The first terminal 2282 of the second inverter 228 is also coupled to the second voltage transmission terminal 224.

While this invention has been described with reference to the illustrative embodiment, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

1. An apparatus for refreshing a voltage data in a display pixel circuit, said voltage data being stored in a capacitor of said display pixel circuit, comprising:
a data refreshing circuit, said data refreshing circuit comprising:
a voltage transmission terminal coupled to said capacitor; and
a first input terminal for inputting a first control signal to control timing and/or period for reading and/or writing said voltage data.

2. The apparatus of claim 1, wherein said display pixel circuit comprises an organic light emitting diode.

3. The apparatus of claim 2, wherein said data refreshing circuit further comprises a second input terminal for inputting a second control signal to control timing and/or period for reading and/or writing said voltage data.

4. The apparatus of claim 3, wherein said data refreshing circuit further comprises:
a memory circuit, including a first voltage transmission terminal and a second voltage transmission terminal, for storing said voltage data;
a first switch unit including a first terminal coupled to said voltage transmission terminal, a second terminal coupled to said first voltage transmission terminal and a third terminal coupled to said first input terminal; and
a second switch unit including a first terminal coupled to said voltage transmission terminal, a second terminal coupled to said second voltage transmission terminal and a third terminal coupled to said second input terminal;
wherein said memory circuit reads said voltage data through said first voltage transmission terminal and writes said voltage data through said second voltage transmission terminal.

5. The apparatus of claim 4, wherein said first switch unit is a thin film transistor, said thin film transistor includes a source acting as said first terminal of said first switch unit, a drain acting as said second terminal of said first switch unit and a gate acting as said third terminal of said first switch unit.

6. The apparatus of claim 4, wherein said second switch unit is a thin film transistor, said thin film transistor includes a source acting as said first terminal of said second switch unit, a drain acting as said second terminal of said second switch unit and a gate acting as said third terminal of said second switch unit.

7. The apparatus of claim 4, wherein said memory circuit includes:
a first inverter including a first terminal and a second terminal; and
a second inverter including a first terminal and a second terminal;
wherein said first terminal of said first inverter is coupled to said second terminal of said second inverter, said second terminal of said first inverter is coupled to said first terminal of said second inverter, said second terminal of said first inverter is coupled to said first voltage transmission terminal, said first terminal of said second inverter is coupled to said second voltage transmission terminal.

8. An organic light emitting diode display, comprising:
a plurality of display pixel circuits, each said plurality of display pixel circuits comprising:
a capacitor for storing a voltage data; and
an apparatus for refreshing said voltage data.

9. The organic light emitting diode display of claim 8, wherein said apparatus comprises a data refreshing circuit, said data refreshing circuit comprising:
a voltage transmission terminal coupled to said capacitor; and
a first input terminal for inputting a first control signal to control timing and/or period for reading and/or writing said voltage data.

10. The organic light emitting diode display of claim 9, wherein said data refreshing circuit further comprises a second input terminal for inputting a second control signal to control timing and/or period for reading and/or writing said voltage data.

11. The organic light emitting diode display of claim 10, wherein said data refreshing circuit further comprises:
a memory circuit, including a first voltage transmission terminal and a second voltage transmission terminal, for storing said voltage data;
a first switch unit including a first terminal coupled to said voltage transmission terminal, a second terminal coupled to said first voltage transmission terminal and a third terminal coupled to said first input terminal; and
a second switch unit including a first terminal coupled to said voltage transmission terminal, a second terminal coupled to said second voltage transmission terminal and a third terminal coupled to said second input terminal;
wherein said memory circuit reads said voltage data through said first voltage transmission terminal and writes said voltage data through said second voltage transmission terminal.

12. The organic light emitting diode display of claim 11, wherein said first switch unit is a thin film transistor, said thin film transistor includes a source acting as said first terminal of said first switch unit, a drain acting as said second terminal of said first switch unit and a gate acting as said third terminal of said first switch unit.

13. The organic light emitting diode display of claim 11, wherein said second switch unit is a thin film transistor, said thin film transistor includes a source acting as said first terminal of said second switch unit, a drain acting as said second terminal of said second switch unit and a gate acting as said third terminal of said second switch unit.

14. The organic light emitting diode display of claim 11, wherein said memory circuit includes:
a first inverter including a first terminal and a second terminal; and
a second inverter including a first terminal and a second terminal;
wherein said first terminal of said first inverter is coupled to said second terminal of said second inverter, said second terminal of said first inverter is coupled to said first terminal of said second inverter, said second terminal of said first inverter is coupled to said first voltage transmission terminal, said first terminal of said second inverter is coupled to said second voltage transmission terminal.
